(19) United States
(12) Patent Application Publication
(10) Pub. No.: US 2026/0148736 A1
(43) Pub. Date: May 28, 2026

(54) System For Generating Response To Multimodal Queries Using Multi-Step Reasoning

(71) Applicant: Google LLC, Mountain View, CA (US)

(72) Inventors: Belinda Luna Zeng, Cupertino, CA (US); Dounia Berrada, Saratoga, CA (US); Damon Chizuru Kawamoto, Santa Cruz, CA (US); Harshit Kharbanda, Pleasanton, CA (US); Louis Wang, San Francisco, CA (US); Sundeep Vaddadi, Los Gatos, CA (US)

(21) Appl. No.: 18/957,250

(22) Filed: Nov. 22, 2024

(51) Int. Cl. G10L 15/16; G10L 15/22

(52) U.S. Cl. CPC G10L 15/16; G10L 15/22; G10L 2015/225

(57) ABSTRACT

The present disclosure provides computer-implemented methods, systems, and devices for responding to a multimodal input query with a large-language model using a multi-step reasoning process. A computing device receives the multimodal input query including image content. The computing device determines that the multimodal input query exceeds a threshold complexity value using a query classification model. The computing device, in response to determining that the multimodal input query exceeds a threshold for complexity, generates a plurality of processing steps for responding to the multimodal input query, including executing at least one subquery. The computing device performs the plurality of processing steps to generate intermediate data. The computing device generates model input based on the intermediate data. The computing device processes the model input with a query response model to generate a model output. The computing device transmits the model output for display at a user computing device.

### FIELD

The present disclosure relates generally to generative large language models. More particularly, the present disclosure relates to a system that identifies queries that require multi-step reasoning and uses an orchestrator system to perform the multi-step reasoning.

### BACKGROUND

As the capability of large language machine-learned models to generate content in response to a prompt continues to increase, there is demand for large language machine-learned models that can respond to increasingly complicated prompts. However, some prompts can be complex. These prompts can require sophisticated, multi-step reasoning to generate an adequate response. The difficulty in responding correctly is made more difficult when the input to the generative large language model is multimodal. It is therefore important to respond to complex prompts in a manner that enables the large language machine-models to produce responses that are accurate and not overly expensive.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can be performed by a computing system comprising one or more processors. The one or more operations comprise steps for responding to a multimodal input query with a large-language model using a multi-step reasoning process. The operations comprise receiving, by the computing system with one or more processors, the multimodal input query, the multimodal input query including image content. The operations comprise determining, by the computing system, that the multimodal input query exceeds a threshold complexity value for query complexity using a query classification model. The operations comprise, in response to determining that the multimodal input query exceeds a threshold for complexity, generating, the computing system, a plurality of processing steps for responding to the multimodal input query, wherein the processing steps include executing at least one subquery based on the multimodal input query. The operations comprise performing, by the computing system, the plurality of processing steps to generate intermediate data. The operations comprise generating, by the computing system, input based on the intermediate data. The operations comprise processing, by the computing system, the model input with a query response model to generate a model output based on the model input. The operations comprise transmitting, by the computing system, the model output for display at a user computing device.

Another example aspect of the present disclosure is directed to a computing system for responding to a multimodal input query with a large-language model using a multi-step reasoning process. The system can include one or more processors and one or more non-transitory computer-readable media that collectively store instructions that, when executed by the one or more processors, cause the computing system to perform operations. The operations can include receiving the multimodal input query, the multimodal input query including image content. The operations can include determining that the multimodal input query exceeds a threshold complexity value for query complexity using a query classification model. The operations can include, in response to determining that the multimodal input query exceeds a threshold for complexity, generating a plurality of processing steps for responding to the multimodal input query, wherein the processing steps include executing at least one subquery based on the multimodal input query. The operations can include performing the plurality of processing steps to generate intermediate data. The operations can include generating model input based on the intermediate data. The operations can include processing the model input with a query response model to generate a model output based on the model input. The operations can include transmitting the model output for display at a user computing device.

Another example aspect of the present disclosure is directed to one or more non-transitory computer-readable media that collectively store instructions that, when executed by one or more computing devices, cause the one or more computing devices to perform operations. The operations can include receiving the multimodal input query, the multimodal input query including image content. The operations can include determining that the multimodal input query exceeds a threshold complexity value for query complexity using a query classification model. The operations can include, in response to determining that the multimodal input query exceeds a threshold for complexity, generating a plurality of processing steps for responding to the multimodal input query, wherein the processing steps include executing at least one subquery based on the multimodal input query. The operations can include performing the plurality of processing steps to generate intermediate data. The operations can include generating model input based on the intermediate data. The operations can include processing the model input with a query response model to generate a model output based on the model input. The operations can include transmitting the model output for display at a user computing device.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 represents an example of a system for responding to complex queries using planning via a reasoning loop in accordance with example embodiments of the present disclosure;

FIG. 2 depicts a query response system in accordance with example embodiments of the present disclosure;

FIG. 3 depicts a query response system in accordance with example embodiments of the present disclosure;

FIG. 4 depicts an example client-server environment according to example embodiments of the present disclosure;

FIG. 5 depicts an example client-server environment according to example embodiments of the present disclosure;

FIG. 6A is a depiction of a multi-step plan for responding to a multimodal input query in accordance with example embodiments of the present disclosure;

FIG. 6B depicts a multi-step plan for responding to a multimodal input query in accordance with example embodiments of the present disclosure;

FIG. 7 is a flow diagram representing a process for generating responses for complex multimodal input queries in accordance with example embodiments of the present disclosure;

FIG. 8 is a block diagram of an example processing flow for using machine-learned model(s) 1 to process input(s) 2 to generate output(s) 3;

FIG. 9 is a block diagram of an example implementation of an example machine-learned model configured to process sequences of information;

FIG. 10 is a block diagram of an example technique for populating an example input sequence 8;

FIG. 11 is a block diagram of an example computing device 98 that performs according to example embodiments of the present disclosure; and

FIG. 12 is a block diagram of an example computing device 99 that performs according to example embodiments of the present disclosure.

Reference numerals that are repeated across plural figures are intended to identify the same features in various implementations.

### DETAILED DESCRIPTION

Generally, the present disclosure is directed toward a query response system that identifies complex queries that require multi-step reasoning and, in response to that determination, performs a series of steps to enable the system to provide an accurate and useful response. Existing models have difficulty properly analyzing and responding to complex queries. Complex queries can include queries needing multiple reasoning steps to respond correctly. A query response system can receive a multimodal input query. The query response system can include an orchestration system with access to one or more large language models (LLM). The orchestration language model can determine whether the multimodal input query is associated with a complex query. If the orchestration system determines that the current multimodal input query is complex, the orchestration model can generate a plan that specifies a series of steps to respond to the query. For example, the orchestration system can, using a classification system, identify one or more objects within an image included in the multimodal input query and extract individual objects from the image. The orchestration system can then generate a plurality of subqueries. One or more of the subqueries can be associated with one or more objects extracted from the image. In some examples, one or more of the subqueries can rely on information from a previously generated subquery. A response generation system can produce a model output that responds to the multimodal input query using the information provided by the subqueries.

For example, if an image includes a series of books and the query requests a recommendation for the highest-rated book in the group, an orchestration system can determine a three-step process for responding to the multimodal input query. First, the orchestration model can analyze the image to extract one or more objects (e.g., books) from the image. The orchestration model can rewrite the textual (or speech) content from the multimodal input query based on the extracted and identified objects. The rewriting process can include generating a plurality of subqueries for each extracted object. In this example, the subquery could include, “what is a quality rating for [insert name of identified book]?” The orchestration system can produce a first set of queries that can identify the particular books in the image, and the second set of queries can retrieve the ratings for those books. Once the identity of the books is determined and the ratings are identified, the orchestration system can provide that information, along with the multimodal input query, to a generative model to prepare a natural language response to the multimodal input query.

More particularly, a query response system can provide responses to input queries submitted via a computer network. In some examples, the responses can include one or more search results, each search result including a link to a web page or other document. In some examples, the search results and a natural language response to the input query can be displayed. In some examples, the input query can be multimodal. A multimodal input query can be an input query that includes at least two types of content. In general, the multimodal input query can include textual content (e.g., a natural language question), speech content (a recording of a user asking a question), and one or more media elements (e.g., an image, a video, a piece of audio content, and so on).

In some examples, it can be difficult for machine-learned models to deal with queries that are informationally dense enough to require more than one reasoning step. For example, if a multimodal input query includes an image that includes specific information and a textual request associated with the information in the image, it can be difficult for traditional machine-learned models to accurately respond to such a query. In some examples, traditional machine-learned models do not take the necessary steps to gain information before attempting to answer. As a result, the accuracy of the responses provided by the traditional machine learning models can be reduced.

To resolve this problem, the present disclosure describes a query response system that includes an orchestration system. An orchestration system can include or have access to a large language model that can take a query as input and, as output, generate a series of steps needed to process the query correctly. The steps can include instructions to access various subsystems to identify portions of the image, generate subqueries, and synthesize information for a final response.

In some examples, the orchestration system can determine whether a respective multimodal input query is complex enough to require a multi-step reasoning process. Thus, as part of processing a multimodal input query, the orchestration system can determine whether or not additional steps are needed to respond to the query. For example, this can include generating a complexity score for a multimodal input query based, at least in part, on image content and textual content included in the multimodal input query. In this way, the orchestration system can determine, based on the complexity score, whether or not to proceed with a more resource-intensive multi-step process or to directly provide an answer to the query without using additional resources.

For example, the orchestration system can provide an image included in the multimodal image query to an object recognition system. The object recognition system can analyze an image (or other media element) to determine one or more objects within the image. In some examples, the output of an object recognition system can be data identifying a plurality of objects within the image. This identification can indicate the portion of the image that includes each identified object. In other examples, the output can be a series of new images, each including only the portion of the original image for a given object.

The orchestration system can also generate a series of queries or subqueries. In some examples, the orchestration system can analyze the multimodal input query to generate a plurality of subqueries. The plurality of subqueries can be generated, at least in part, by rewriting the textual portion of the multimodal input query. In some examples, the subqueries can be determined based on the outcome of the object recognition system. In other examples, the subqueries can be determined based on the textual content in the multimodal input query. The orchestration system can determine that the generated subqueries can be analyzed in a particular order or using a particular structure.

For example, a multimodal input query can include a photograph of a plurality of foods available in a fridge or a pantry. The multimodal input query can include a textual prompt that says, “recommend a healthy meal I can make from the ingredients in this image.” In response, the orchestration system can provide the image to an object detection system to detect a plurality of food items within the image.

Once the plurality of objects are detected within the image, the orchestration system can generate a series of subqueries. Each subquery can include a particular portion of the original image and a query requesting that the food be identified. Each subquery can be provided to a system that can identify the food depicted in the image.

The subqueries can be issued to a search system, and responses can be received. The orchestration system can synthesize the information included in each response into a single response. In some examples, the responses can be used to generate additional subqueries. Using the above example, if the initial queries were used to determine the types of food in the pantry or refrigerator, a second set of subqueries can be generated to request recipes based on a list of those foods. A third set of subqueries can be generated to evaluate each recipe to evaluate the degree to which the recipe is healthy.

Once all the queries have been completed, the orchestration system can input those details (e.g., the results of each set of subqueries, the original multimodal input query, and any contextual information) into a prompt for a response generation model (e.g., a sequence processing machine-learned model for responding to queries based on the input prompt). The input to the response generation model can then generate a model output. The model output can include a natural language explanation of a response for the input query.

The model output (e.g., the natural language response) can be transmitted to a user computing device associated with a user. In some examples, the model output can be transmitted to a user computing device along with a list of search results generated by a web search system. The model output can be displayed on a web page along with a plurality of search results. For example, the model response can be displayed in an interface element box above the other search results. The model response can include a summary of the information relevant to the multimodal input query.

The systems and methods of the present disclosure provide a number of technical effects and benefits. As one example, the systems and methods can reduce the latency and the amount of computation resources needed to generate an accurate response to a multimodal input query that requires multi-step reasoning. Automatically and accurately determining a series of steps for responding to a multimodal input query can significantly reduce the time and cost needed to produce accurate results by a machine-learned model.

Another example of technical effect and benefit relates to improved computational efficiency and improvements in the functioning of a computing system. For example, a technical benefit of the systems and methods of the present disclosure is the ability to selectively use the orchestration system only when the multimodal input query is sufficiently complex to benefit from multi-step reasoning. In this way, the more complex response system can be used when needed, but when the multimodal input query is not complex, the query response system can avoid the use of the more resource-intensive system. This allows the query response system to reduce power usage and processor usage of the system providing the generative model.

With reference now to the Figures, example embodiments of the present disclosure will be discussed in further detail.

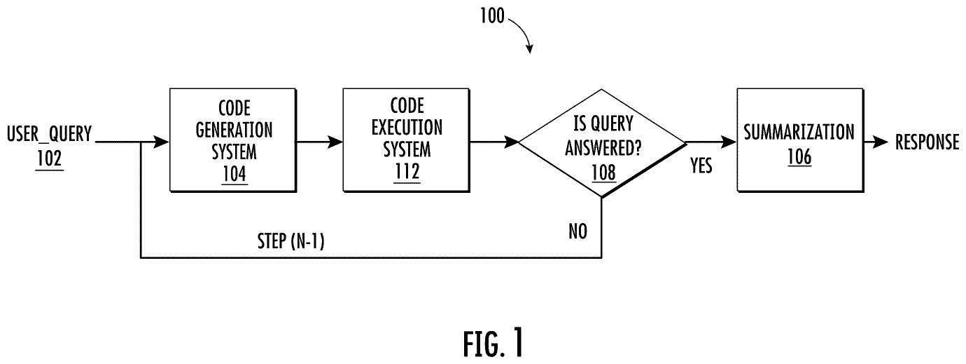

FIG. 1 represents an example of a query response system 100 for responding to complex queries using planning via a reasoning loop in accordance with example embodiments of the present disclosure. In this example, a query response system can receive an input query 102. The input query 102 can be multimodal and include two or more types of content. For example, the two or more types of content can include textual content and/or one or more media elements. The media elements can include image content, video content, audio content, interactive content, etc.

In some examples, the query response system 100 can perform query classification to determine a complexity value associated with the query. In some examples, this classification can be performed by an orchestration system (e.g., an orchestrator large language model (LLM)). The orchestration system (or an associated machine-learned model such as an orchestrator LLM) can analyze queries and allow the query response system 100 to respond effectively to those queries. In some examples, if the complexity value exceeds the threshold complexity value, the query response system can provide the query to a code generation system 104 for responding to complex queries.

If the orchestration system classifies the user input query as complex, the query can be provided to a code generation system 104. The code generation system 104 can be a planning system. The code generation system 104 can take a multimodal query as input and output a series of steps for responding to the multimodal input query. This series of steps may be represented as executable instructions (e.g., code or pseudocode) that a code execution module 112 of the orchestrator system can execute. In some examples, the code execution module 112 can perform a series of actions based on the output of a planning system (e.g., the code generation system 104). For example, the series of actions can include instructions to analyze an image, extract one or more objects from the image, and provide the series of subqueries to be issued based on the multimodal input query. These subqueries can be based on the textual content of the multimodal input query or one or more aspects of the image.

The code execution module 112 can contact existing services to perform the instructions received from the code generation system 104. For example, a machine learning model may exist that is trained to take the image as input and output a list of identified objects within the image. Similarly, one or more search systems can be provided with subqueries. The search systems can include multimodal search systems that can take the image or portion of the image as input, along with textual instructions.

Once each step from the code generation system 104 has been executed by the code execution module 112, an evaluation system can determine whether the steps that have already been taken have provided enough information to resolve the query. For example, the evaluation system can include a machine-learned model that takes the input query, results of any steps taken, and other contextual information as input and outputs an indication of whether the information generated is sufficient to answer the query. In some examples, this can be represented as a confidence value. If the confidence value exceeds a predetermined threshold, the gathered materials are determined to be sufficient to respond to the input query. If the value is below a threshold, the gathered materials can be determined to be insufficient to respond to the input query.

If the evaluation system determines that the steps taken so far are insufficient to respond to the multimodal input query fully, the existing materials can be returned to the planning module 110. Based on the steps taken and materials gathered, the code generation system 104 can determine one or more future steps needed to respond to the query adequately. These steps can be provided to the execution system 112. The execution system can again execute searches, analyze images, etc., as directed by the code generation system 104. Once further steps have been taken, additional information can be provided to the evaluation system 108, and a new evaluation can be conducted. This loop can be repeated until the evaluation system 108 determines that the information gathered is sufficient to respond to the multimodal input query.

Once the evaluation system 108 determines that the information is sufficient to respond to the multimodal input query, the information gathered can be provided to a summarization system 106 (or directly to a response generation system). The summarization system 106 can include a machine-learned model that can take, as input, the multimodal input query 102, the gathered materials, and any other context generated by the planning system. In some examples, the code generation system 104 can generate additional steps, including rewriting or generating additional queries. The additional queries (or rewritten queries) can be provided for the summarization system 106. The summarization system 106 can include a sequence processing machine-learned model that can generate a model output based on the input provided. The output can be a natural language response to the multimodal input query 102. This model response can be transmitted to the requested user.

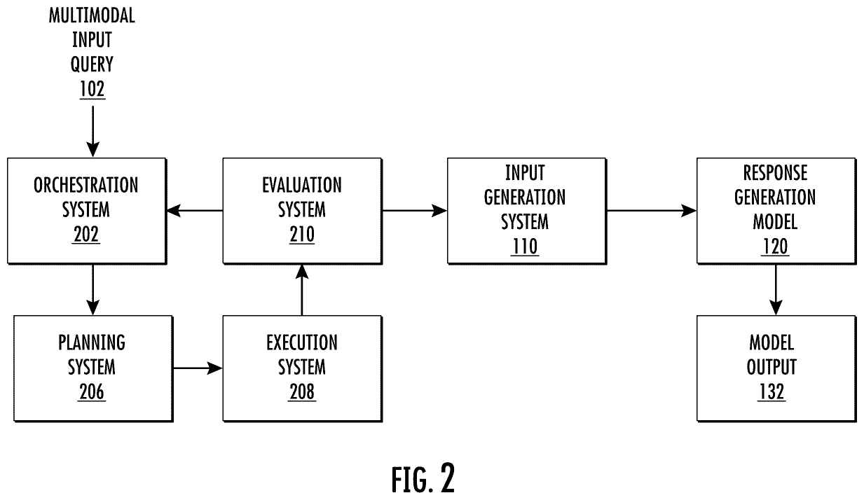

FIG. 2 depicts a query response system in accordance with example embodiments of the present disclosure. In this example, the query response system 100 receives a multimodal input query 102. The multimodal input query can be transmitted to an orchestration system 202. The orchestration system 202 can include a large language model (LLM). An LLM can be a machine-learned model trained to process multimodal input queries. For example, the LLM can be a large vision language model.

In some examples, the orchestration system 202 can determine a complexity score for a particular multimodal input query. The complexity score can represent the degree to which the multimodal input query represents a complex problem or a problem requiring multi-step reasoning. If the orchestration system 202 determines that a particular multimodal input query is complex (e.g., it has a complexity score above a predetermined threshold value), the orchestration system 202 can provide the multimodal input query 102 to a planning system 206. In some examples, the planning system 206 can be a part of the orchestration system 202. In other examples, the planning system 206 can be distinct from the orchestration system 202.

In some examples, the orchestration system 202 can be configured to receive a multimodal input query 102 as input and generate, as output, a list of steps to generate a response to the query. Each step can be associated with a particular instruction or piece of pseudo code. As a result, the output of the planning system 206 can be a series of steps to be performed to generate an adequate response to the multimodal input query 102.

In some examples, a list of steps can be provided to an execution system 208. The execution system 208 can be designed to receive, from a planning system 206, a list of instructions or steps to be performed. Each step can be associated with a particular action to be taken. The steps can include analyzing a particular image, extracting or identifying a plurality of objects within the image, generating a plurality of subqueries, rewriting one or more queries, accessing database information, and so on.

The execution system 208 can perform each step in the list of steps provided by the planning system 206. Each step can be associated with a particular sub-system. For example, an object detection system can be associated with an image analysis model that takes an image as input and outputs a list of objects within that image. In some examples, the subsystems are associated with the orchestration system 202. In other examples, the various subsystems that perform the steps are communicatively accessible via computing network communications but are not part of the orchestration system 202 itself.

The execution system 208 can perform each step. In some examples, the order in which the steps are performed is determined by the list of steps output by the planning system 206. In other examples, one or more steps may rely on the output of a previous step. In this way, the execution system 208 can first perform a particular step, receive its result, and use that result to process and perform a second step.

Once the execution system 208 has performed all steps outlined in the list of steps received from the planning system 206, the execution system 208 can provide the resulting information to an evaluation system 210. In addition to the results of each step, the execution system 208 can also provide any input including the multimedia input query, any identified objects or portions of the image, any rewritten queries, and so on.

The evaluation system 210 can take, as input, the output generated by the execution system, the multimodal input query, any intermediate steps in the process, and any other contextual information relevant to the steps executed by the execution system 208. The evaluation system 210 can be a machine-learned model that takes the output from the execution system 208, the original multimodal input query, and any other contextual information as input and generates, as output, a determination indicating whether the information retrieved by the execution system 208 is sufficient to respond to the query adequately. In some examples, this output can be represented as a confidence value. If so, there could be a confidence threshold above which the evaluation system 210 determines that the intermediate data generated by the execution system 208 is sufficient, and below which the system determines that the intermediate data is insufficient.

If the evaluation system 210 determines that the intermediate information generated by the execution system 208 is not sufficient to respond to the multimodal input query 102, the evaluation system 210 can return the intermediate data and any associated contextual data to the orchestration system 202. The orchestration system 202 can repeat this process, providing the intermediate data to the planning system 206 to generate a series of steps to be performed. The execution system 208 can then execute these steps, and the evaluation system 210 can determine whether the updated intermediate data is sufficient to respond to the multimodal input query 102. This process can be repeated until the evaluation system 210 determines that the intermediate data is sufficient.

The evaluation system 210 can then provide the intermediate data, the multimodal input query 102, and any contextual data to an input generation system. The input generation system 110 can generate input for a generative model that includes the multimodal input query 102, any generated intermediate data, as well as any contextual data generated during the planning and execution phases of the process. This input can be provided to the response generation model 120. The response generation model 120 can combine or synthesize all this data and generate a response to the multimodal input query 102. The response can be a model output. The model output includes a natural language explanation, answer, or response to the multimodal input query 102.

Once the model output 132 has been generated, the query response system can provide the output to a computing device associated with the user who submitted the multimodal input query. For example, the model can be transmitted over a computer communication network to the requesting user's computing device and displayed to the user. In some examples, the model output can be displayed on a page of web search results.

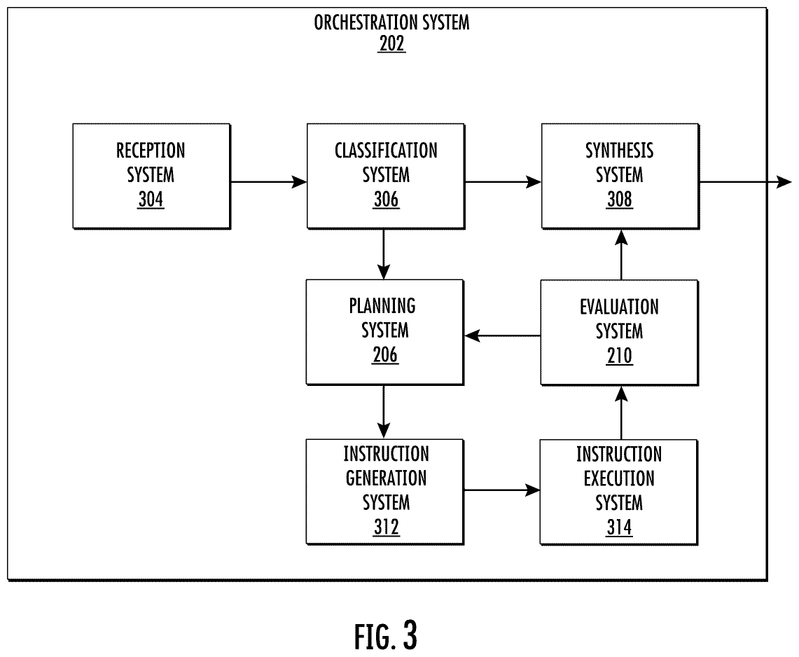

FIG. 3 depicts an orchestration system 202 in accordance with example embodiments of the present disclosure. An orchestration system 202 can include a reception system 304, a classification system 306, a planning system 206, an instruction generation system 312, an instruction execution system 314, an evaluation system210, and a synthesis system 308. In this example, the orchestration system 302 is depicted as a single system with multiple components. However, the orchestration system 302 can also be a series of individual components, each of which communicates and interacts with each other without being part of the same physical computing system. Thus, each system depicted within the orchestration system 202 may be combined or included in other systems while still providing the same essential functions. In this way, any portion of the depicted orchestration system 202 can be grouped or combined in any other way.

A reception system 304 can be a system that receives a multimodal input query. The multimodal input query can be submitted by a user from a user computing device via a computer communication network. In other examples, the orchestration system 202 can be part of a server system that provides web pages to users. The users can interact with a web page provided by the server system and submit a multimodal input query. The multimodal input query can then be delivered to the orchestration system 202 via the reception system 304.

Once the reception system 304 has received the multimodal input query, it can be provided to a classification system 306. In some examples, the classification system 306 can comprise a machine-learned classification model. The classification system 306 can take, as input, the multimodal input query and determine whether the multimodal input query exceeds a predetermined threshold of complexity. For example, a classification system 306 can be trained to determine whether the multiple input query requires multi-step reasoning.

The classification system 306 can output a complexity score (or other indication representing the complexity of the multimodal input query). If the classification system determines that the multimodal input query is not complex (e.g., does not require multi-step reasoning), the multimodal input query could be provided to the synthesis system 308 without further processing by the orchestration system 302. In contrast, if the classification system 306 determines, based on the complexity score provided by a classification model, that the multimodal input query is complex (e.g., requires multi-step reasoning), the classification system 306 can provide the multimodal input query to the planning system 310.

The planning system 310 can be a system that takes a multimodal input query as input and generates a plan for responding the multimodal input query. For example, the plan can include a series of steps and a specific order to perform each step. In some examples, the plan can include steps in which one or more media elements are analyzed, search queries are executed, and data is synthesized. In some examples, the planning system 310 can utilize a machine-learned model trained to generate plans to respond to a complex multimodal input query. The generated plan can start with a multimodal input query and describe a series of steps to generate a response to the query. For example, the planning system can output an estimated series of steps, information on what each step should contain, and what the execution system should expect as a result of each step.

Once the planning system 310 has generated a generalized plan, the plan can be provided to an instruction generation system 312. The instruction generation system 312 can process the generalized plan to generate a series of executable instructions. In some examples, the series of executable instructions can be formatted as code or pseudocode to be executed.

In some examples, the executable instructions can include performing image detection on an image, subdividing an image into portions with relevant objects, generating or rewriting the query to access information requested by the generalized plan, and instructions on how to use retrieved information in future steps of the plan. For example, if the multimodal input query includes an image of a series of vehicles with a question of which model sold the most vehicles in 2002, the generalized plan can include identifying each vehicle pictured in the image. A query can be generated for each vehicle pictured in the image to identify the specific make and model. Once the image analysis system has identified the make and model for each vehicle in the image, the execution system can generate subqueries to retrieve the sales data for each particular make and model for the specified year. Thus, the search results that identified the make and model of each vehicle can be used when generating the second round of queries to identify sales data.

The instruction generation system 312 can generate a series of executable instructions following the plan from the planning system 310. The series of executable instructions can be provided to the instruction execution system 314. The execution instruction system 314 can perform the specific task for each instruction included in the list of instructions generated by the instruction generation system 312. For example, if the first instruction is to identify all the objects in an image, the instruction execution system 314 can provide the image to an object detection system. A search system can perform search steps. Each instruction can have an associated service that is communicatively coupled to the instruction execution system 314. The instruction execution system 314 can transmit requests to the appropriate service system and receive the results of the request. For example, if a particular instruction requires search of a database, the instruction execution system 314 can transmit an appropriate search query to a search system and can receive the search results once the search is complete.

Once the instruction execution system 314 has executed all of the instructions generated by the instruction generation system 312, the results of the instructions can be provided to the evaluation system 316. Based on the multimodal input query, the evaluation system 316 can determine whether the resulting information is sufficient to generate a response to the multimodal input query. In accordance with a determination that it does have sufficient information, the evaluation system 316 can transmit the information to the synthesis system 308.

In accordance with the determination that the information generated by the instruction execution system 314 is insufficient to respond to the multimodal input query satisfactorily, the evaluation system 316 can return that information to the planning system 310. The planning system 310 can, based on the multimodal input query and the information generated by the instruction execution system (including information about the image as well as any search data retrieved), generate an updated plan for responding to the multimodal input query.

This process of generating a plan, determining one or more instructions to fulfill the plan, executing the instructions, and evaluating the results of the instructions can continue until the evaluation system 316 determines that the information generated by the orchestration system 202 is sufficient to respond adequately to the multimodal input query. When this has been determined, the synthesis system 308 can synthesize the gathered data into a useful format and provide it to a generative machine-learned model. The generative machine learning model can generate a model output that serves as a response to the multimodal input query.

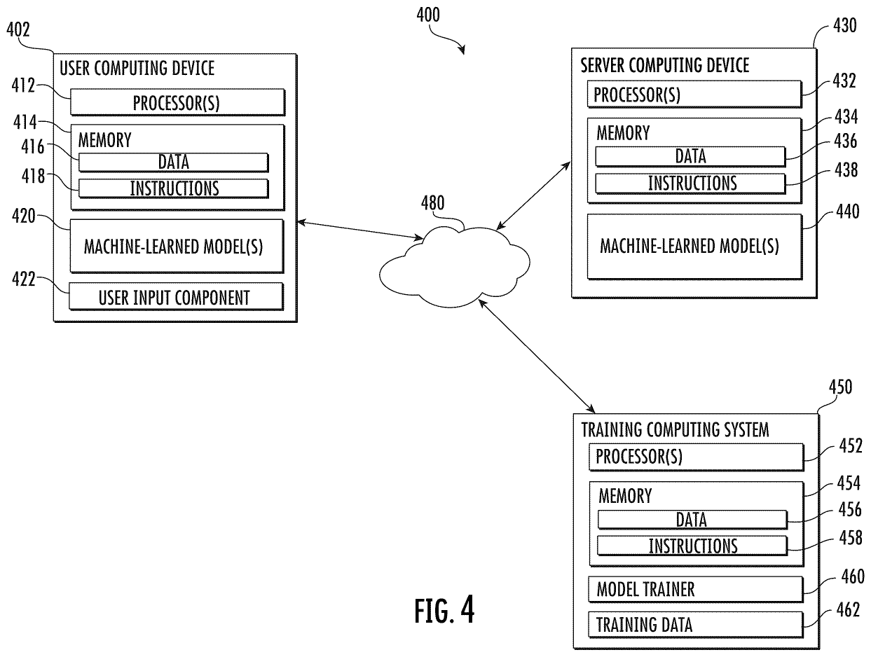

FIG. 4 depicts a block diagram of an example computing system 400 for responding to complex multimodal input queries according to example embodiments of the present disclosure. The computing system 400 includes a computing device 402, a server computing system 430, and a training computing system 450 that are communicatively coupled over a network 480.

The computing device 402 can be any type of computing device, such as a personal computing device (e.g., laptop or desktop), a mobile computing device (e.g., smartphone or tablet), a gaming console or controller, a wearable computing device, an embedded computing device, or any other type of computing device.

The first computing device 402 includes one or more processors 412 and a memory 414. The one or more processors 412 can be any suitable processing device (e.g., a processor core, a microprocessor, an ASIC, an FPGA, a controller, a microcontroller, etc.) and can be one processor or a plurality of processors that are operatively connected. The memory 414 can include one or more non-transitory computer-readable storage mediums, such as RAM, ROM, EEPROM, EPROM, flash memory devices, magnetic disks, etc., and combinations thereof. The memory 414 can store data 416 and instructions 418, which are executed by the processor 412 to cause the user computing device 402 to perform operations.

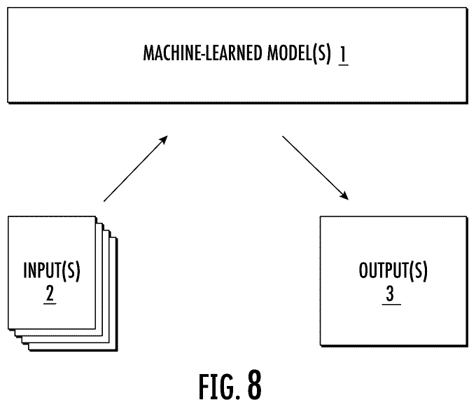

In some implementations, the first computing device 402 can store or include one or more machine-learned models 420 (e.g., a sequence processing model, other types of generative models, and/or an evaluation model). For example, the machine-learned models 420 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example machine-learned models 420 are discussed with reference to FIGS. 8-12.

In some implementations, the one or more machine-learned models 420 can be received from a server computing system 430 over network 480, stored in the memory 414 of the user computing device 402, and then used or otherwise implemented by one or more processors 412. In some implementations, the first computing device 402 can implement multiple parallel instances of a single machine-learned model 420.

More particularly, the machine-learned model 420 (e.g., a sequence processing model) can respond to complex or multi-step multimodal input queries. To do so, the query response system can receive a multimodal query. The multimodal query can include textual content and one or more media elements. As discussed above, the media elements can consist of one or more of: image content, video content, audio content, and interactive content.

A query response system can process the multimodal input query. In some examples, the query response system can provide the multimodal input query to an orchestration system. The orchestration system can include a large language model and can enable the query response system to handle complex queries requiring multi-step reasoning. For example, the orchestration system can use a large language model to classify whether the multimodal input query requires complex or multi-step reasoning. If so, the multimodal input query can be provided to a planning system. If not, the query response system can generate a response directly without the need to access the other aspects of the orchestration system.

In some examples, the planning system can include a machine-learned model that takes a complex query as input and outputs a series of steps that can be used to respond adequately to the query. In some examples, the query response system can analyze the image to generate a written description of the contents of the image before providing it to the planning system. In other examples, the planning system can be a large image machine-learned model that can take both text and image as input without converting the image into text first.

In some examples, the planning system can output a series of instructions for gathering the appropriate information needed to respond adequately to the multimodal input query. As discussed above, such steps can include analyzing the image (or other media elements) to identify specific objects. The instructions can also include generating queries or rewriting existing queries to access information needed by future steps in the multi-step reasoning process. In some examples, the planned system can output a list of steps that can be executed. In some examples, these steps can be represented as lines of code or pseudocode. Each instruction can include a specific operation to perform, a particular service or system to perform the operation, and an expected output. Some instructions can include using the output of previous instructions. If so, the planning system can include instructions on how to use the data provided by previous instructions when performing the current instructions.

Once the execution system has completed all of the tasks in the list of instructions from the planning system, an evaluation system can determine whether the information that has been gathered so far is sufficient to respond to the query correctly. In some examples, an evaluation system can determine that an acceptable response can be generated based on the data that has already been retrieved. In another example, the evaluation system can determine that the execution of the instructions has not yet resulted in enough information to respond to the multimodal input query adequately. If so, the evaluation system can return the multimodal input query and any gathered data to the orchestration system (or planning system) for further evaluation. Based on the initial multimodal input query and the data gathered as a result of one or more steps, the planning system can determine future steps that need to be performed to respond to the multimodal query successfully. This process can be repeated until the evaluation system determines that sufficient information has been gathered to respond to the query.

In some examples, once the evaluation system has determined that it has gathered enough information to respond to the query adequately, it can provide the data gathered and the multimodal query to a synthesis system. The synthesis system can organize and process the information gathered to generate a response to the multimodal input query. In some examples, the plan generated by the planning system can be used to collect and organize the information for future use correctly.

The synthesis process can output information for use in a model input. The model input can be a prompt for a generative model that includes the multimodal input query. The size of the input can be determined based on the maximum allowable input. The model input can include the multimodal input query, including any text or media elements, the specific plan generated by the planning system, the information generated as those steps were executed, and the information generated by the synthesis system.

A machine-learned sequence processing model can generate a model output in response to the multimodal input query based on this model input. The model's output can include, among other things, a natural language explanation of the response to the query, additional media elements that can help explain any aspects of the query that need visual representation, audio content for playing sounds to the user, and so on.

In some examples, the model output can be transmitted to a user computing device associated with the user, where the natural language response provides information about the multimodal input query. In some examples, the model output can be displayed on a web page above a plurality of search results.

In some examples, the model output can include citation information that describes the source of each piece of information included in the model output. For example, citation information can be provided in the input to the model, where citation information is necessary to define where the information can be verified. For example, the citation information can be a web page from which the passage was derived.

FIG. 4 depicts an example client-server environment 400 according to example embodiments of the present disclosure. The client-server system environment 400 includes one or more user computing systems 402 and a computing system 420. One or more communication networks 450 can interconnect these components. The one or more communication networks 450 may be any of a variety of network types, including local area networks (LANs), wide area networks (WANs), wireless networks, wired networks, the Internet, personal area networks (PANs), or a combination of such networks.

The user computing device 402 can also include one or more user input components 422 that receive user input. For example, the user input component 422 can be a touch-sensitive component (e.g., a touch-sensitive display screen or a touchpad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 430 includes one or more processors 432 and a memory 434. The one or more processors 432 can be any suitable processing device (e.g., a processor core, a microprocessor, an ASIC, an FPGA, a controller, a microcontroller, etc.) and can be one processor or a plurality of processors that are operatively connected. The memory 434 can include one or more non-transitory computer-readable storage mediums, such as RAM, ROM, EEPROM, EPROM, flash memory devices, magnetic disks, etc., and combinations thereof. The memory 434 can store data 436 and instructions 438 which are executed by the processor 432 to cause the server computing system 430 to perform operations.

In some implementations, the server computing system 430 includes or is otherwise implemented by one or more server computing devices. In instances in which the server computing system 430 includes plural server computing devices, such server computing devices can operate according to sequential computing architectures, parallel computing architectures, or some combination thereof.

As described above, the server computing system 430 can store or otherwise include one or more machine-learned models 440 (e.g., a sequence processing model, a scoring model, or other machine-learned models used by a query response system). For example, the models 440 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 440 are discussed with reference to FIGS. 8-12.

The computing device 402 and/or a server computing system 430 can train the models 420 and/or 440 via interaction with the training computing system 450, which is communicatively coupled over the network 480. The training computing system 450 can be separate from or a portion of the server computing system.

The training computing system 450 includes one or more processors 452 and a memory 454. The one or more processors 452 can be any suitable processing device (e.g., a processor core, a microprocessor, an ASIC, an FPGA, a controller, a microcontroller, etc.) and can be one processor or a plurality of processors that are operatively connected. The memory 454 can include one or more non-transitory computer-readable storage mediums, such as RAM, ROM, EEPROM, EPROM, flash memory devices, magnetic disks, etc., and combinations thereof. The memory 454 can store data 456 and instructions 458 which are executed by the processor 452 to cause the training computing system 450 to perform operations. In some implementations, the training computing system 450 includes or is otherwise implemented by one or more server computing devices.

The training computing system 450 can include a model trainer 460 that trains the machine-learned models 420 and/or 440 stored at the user computing device 402 and/or the server computing system 430 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 460 can perform a number of generalization techniques (e.g., weight decays, dropouts, etc.) to improve the generalization capability of the models being trained.

In particular, the model trainer 460 can train the query response system and the orchestration system based on a set of training data 462. The training data 462 can include, for example, example ratings of various types of outcomes for responding to a multimodal input query, generating a plan for responding to a query, classifying a query as complex, and so on. In some examples, the model trainer 460 can use entailment output (or other feedback) from an evaluation system.

The model trainer 460 includes computer logic utilized to provide desired functionality. The model trainer 460 can be implemented in hardware, firmware, and/or software controlling a general-purpose processor. For example, in some implementations, the model trainer 460 includes program files stored on a storage device, loaded into a memory and executed by one or more processors. In other implementations, the model trainer 460 includes one or more sets of computer-executable instructions that are stored in a tangible computer-readable storage medium such as RAM hard disk or optical or magnetic media.

The network 480 can be any type of communications network, such as a local area network (e.g., intranet), wide area network (e.g., Internet), or some combination thereof and can include any number of wired or wireless links. In general, communication over the network 380 can be carried via any wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases. In some implementations, the input to the machine-learned model(s) of the present disclosure can include image data. The machine-learned model(s) can process the image data to generate an output based on a request. As an example, the machine-learned model(s) can process the image data to generate a new image by extracting information from the image data and updating or modifying it based on the request.

In some implementations, the input to the machine-learned model(s) of the present disclosure can be text or natural language data. The machine-learned model(s) can process the text or natural language data to generate an output. As an example, the machine-learned model(s) can process the natural language data included in a multimodal input query and generate a prompt based on the multimodal input query.

In some implementations, the input to the machine-learned model(s) of the present disclosure can be speech data. The machine-learned model(s) can process the speech data to generate an output. As an example, the machine-learned model(s) can process the speech data to generate a speech recognition output. The output of the speech recognition system can be used as input to the image generation model.

FIG. 4 illustrates an example computing system that can be used to implement the present disclosure. Other computing systems can be used as well. For example, in some implementations, the user computing device 402 can include the model trainer 460 and the training dataset 462. In such implementations, the model(s) 420 can be trained and used locally at the user computing device 402. In some implementations, the user computing device 402 can implement the model trainer 460 to personalize the models 420 based on user-specific data.

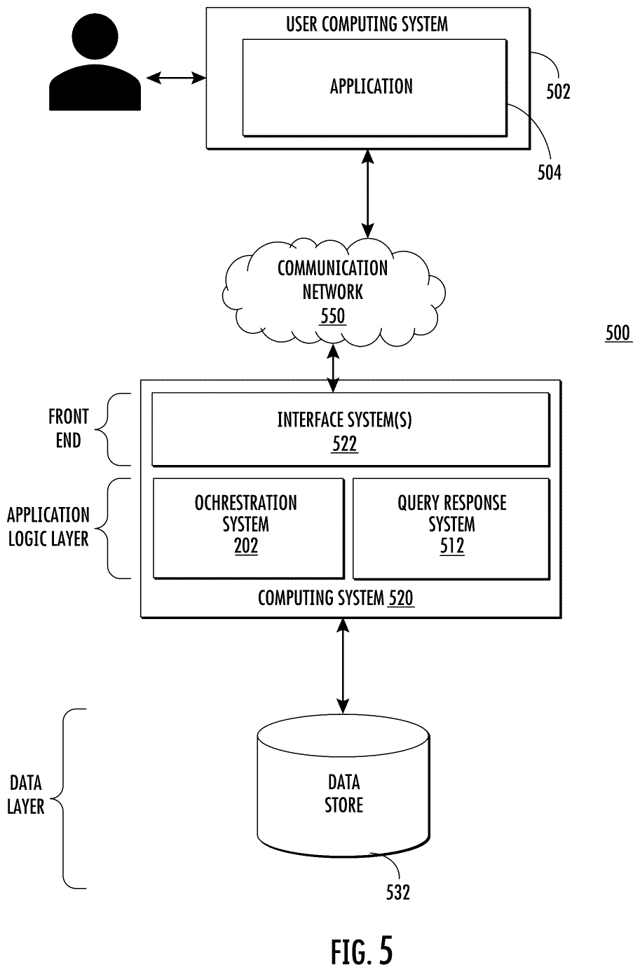

FIG. 5 depicts an example client-server environment 500 according to example embodiments of the present disclosure. The client-server system environment 500 includes one or more user computing systems 502 and a server computing system 520. One or more communication networks 550 can interconnect these components. The one or more communication networks 450 may be any of a variety of network types, including local area networks (LANs), wide area networks (WANs), wireless networks, wired networks, the Internet, personal area networks (PANs), or a combination of such networks.

A user computing system 502 can be one of, but is not limited to, a personal computing system, a smartphone, a smartwatch, a laptop computing device, and a tablet computing system. In some examples, the user computing system 502 can include one or more application(s) 504, such as search applications, communication applications, navigation applications, productivity applications, game applications, word processing applications, an image search application, or a query requesting application, or any other applications. The application(s) can include a web browser. The user computing system 502 can use an application associated with a query response system to send and receive requests to and from the server computing system 520. The user computing system 502 can transmit a request to the server computing system 520. The request can be a multimodal input query. The server computing system 520 can provide the request as part of a prompt to the response generation system and provide a query response to the user computing system 502.

As shown in FIG. 5, the server computing system 520 can generally be based on a three-tiered architecture, consisting of a front-end layer, application logic layer, and data layer. As is understood by skilled artisans in the relevant computer and Internet-related arts, each component shown in FIG. 5 can represent a set of executable software instructions and the corresponding hardware (e.g., memory and processor) for executing the instructions. To avoid unnecessary detail, various components and engines that are not germane to conveying an understanding of the various examples have been omitted from FIG. 5. However, a skilled artisan will readily recognize that various additional components, systems, and applications may be used with a computing system 420, such as that illustrated in FIG. 5, to facilitate additional functionality that is not specifically described herein. Furthermore, the various components depicted in FIG. 5 may reside on a single server computer or may be distributed across several server computers in various arrangements. Moreover, although server computing system 520 is depicted in FIG. 5 as having a three-tiered architecture, the various examples of embodiments are not limited to this architecture.

As shown in FIG. 5, the data layer can include a data store 532. The data store 532 can store the data used to produce search results in response to a multimodal input query. In some examples, the data store 532 can represent a plurality of distinct databases, each database storing one type of document. For example, the data store can include a plurality of documents, each indexed and/or embedded into an embedding space to allow for searchability or comparison to an input query. In some examples, the data store 532 (or a database associated with the data store 532) includes a plurality of embedded images. Each embedded image can be related to one or more documents.

The application logic layer can include application data that provides a wide range of other applications and services, allowing users to submit queries and receive responses. The application logic layer can include an orchestration system 202 and a query response system 120.

When a user computing system 502 transmits a multimodal input query to the server computing system 520, the interface system 522 can provide the multimodal input query to the orchestration system 302 to determine whether the multimodal input query is complex and whether a multi-step reasoning process is required. The orchestration system 202 can execute a plurality of steps to analyze the multimodal input query and retrieve additional data for responding to the multimodal input query. The additional data can be provided to the query response system 512.

More specifically, the multimodal input query can be provided to the orchestration system 202. The orchestration system 202 can process the multimodal query. In some examples, the orchestration system 202 can classify the multimodal input query as either complex or not complex. A complex query can be a query that needs a multi-step reasoning process to respond to the multimodal input query adequately. In some examples, the classification could be provided by a machine-learned model that takes a multimodal input query as input and outputs a score associated with the complexity of the multimodal input query. In some examples, there can be a predetermined threshold complexity value. A multimodal input query that exceeds the threshold value is determined to be complex. In contrast, multimodal input queries that do not exceed the threshold query are not determined to be complex.

If a multimodal input query is not complex, it can be provided to the query response system 512 immediately, and the query response system can generate a model output. If the orchestration system 202 determines that the multiple input query is complex, the orchestration system 202 can provide the multimodal input query to a planning system. The planning system can be a machine-learned model that takes a multimodal input query as input and outputs a series of steps needed to resolve the multimodal input query. A series of steps can include analyzing an image to extract images, generating a plurality of subqueries, determining how to use the responses to those queries to answer future steps in the process, and so on.

Once the planning system has determined a specific plan to generate the data needed to resolve the query, the execution system can execute each step in the plan. In some examples, the execution system can access existing services to perform the steps as required. For example, suppose a particular step is to identify a number of objects in an image. In that case, the execution system can provide the image to a model that is trained to determine the objects in an image. Similarly, if the execution system determines that a series of queries are needed to gather information, the execution system can generate a series of queries based on the original multimodal input query and the output of the planning system. Each step can then be executed to retrieve data from the data store 532 or another source.

In some examples, some actions require the output of the previous action to be executed. For example, if an input query includes a series of books in an image, the orchestration system 202 can first identify objects in the image. Once the objects have been identified, the orchestration system 202 can determine the identity of each book. Then a subquery can be generated using the identification of the book to retrieve further information about that book.

Once all the steps in the plan have been executed and any data has been retrieved, the evaluation system can determine whether the steps performed so far, including any information retrieved, are sufficient to generate an adequate response to the multimodal input query. If the evaluation system determines that the existing steps are not sufficient to respond fully to the multimodal input query, the process can be repeated with the planning system generating additional steps and the execution system executing those steps. Once the evaluation system determines that the steps taken have been adequate to generate a response to the multiple input query, the information can be provided to the query response system 512. For example, the multimodal input query, any data gathered or objects identified from an image, and any contextual information generated during the multi-step reasoning process can be provided as input to the query response system 512.

The query response system 512 can accept the input, including any retrieved data and the multimodal input query. Based on that input, the query generation model can generate a model output. The output can include a natural language response to the input query based at least in part on the image or other media element included in the multimodal input query.

The server computing system 520 can transmit the model output to the user computing device 102 for display. In some examples, the model output can be displayed on a page with the plurality of other search results. For example, the output is displayed with information about the source of each particular piece of item included in the model output. In this way, the user can verify that the information in the model output is accurate.

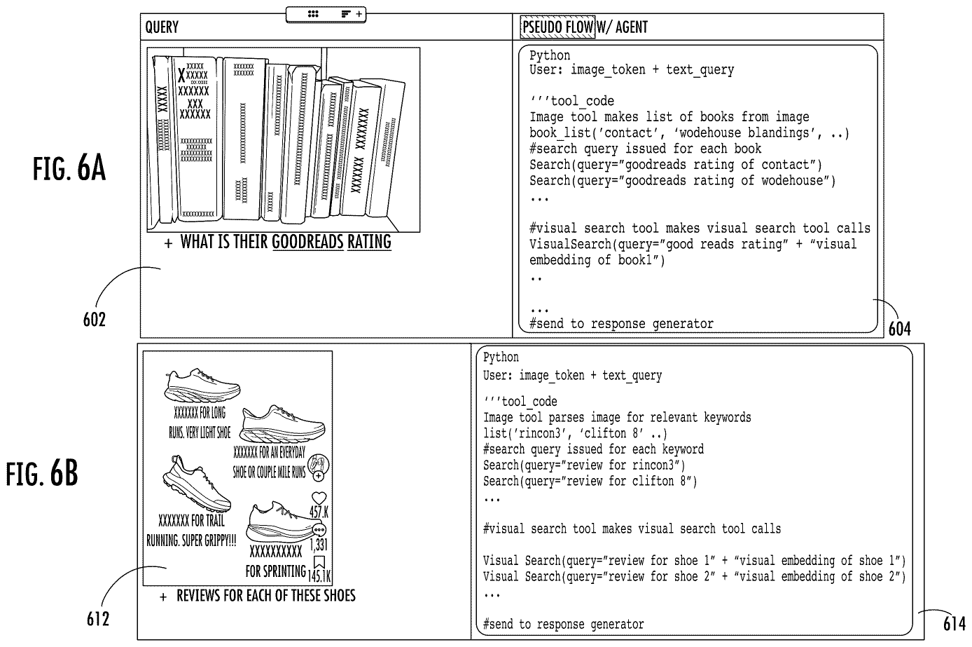

FIG. 6A is a depiction of a multi-step plan for responding to a multimodal input query in accordance with example embodiments of the present disclosure. A multimodal input query includes an image 602 and textual content. In this case, the textual content is “what is their good reads rating.” This multimodal input query can be provided to an orchestration system. Using a planning system, the orchestration system can generate a series of steps or instructions for responding to the multimodal input query. In this example, the instruction steps can be represented as pseudo code.

The steps include examining the image to determine a list of books from the image. Once the image has been analyzed, the identified books can be stored in a book list data structure. Once the list of books has been determined, the orchestration system can generate a series of subqueries. Each subquery can request a rating for a book in the list of books.

The steps can include performing, by a visual search tool, a visual search for search results based on a visual embedding of the book, along with a text prompt. In this case, the text prompt is “goodreads rating.” Once the search results have been received, the information will be transmitted to a response generation system.

FIG. 6B depicts a multi-step plan for responding to a multimodal input query in accordance with example embodiments of the present disclosure. In this case, a multimodal input query includes an image 612 and textual content. In this case, the image includes a plurality of shoe types, and the textual content reads “reviews for each of these shoes.” The image also includes text describing each shoe.

In this example, the steps generated by the orchestration system include using image tools to parse the image. The image tools can extract objects from the image as well as relevant keywords. Using the extracted objects and the relevant keywords, the orchestration system can generate a list of shoes included in the image. Once the list of shoes has been generated, the orchestration system can generate a series of subqueries. Each subquery can search for reviews for a particular shoe in the list of shoes.

The steps can include performing, by a visual search tool, a visual search on a visual embedding of a shoe, along with a text prompt. In this case, the text prompt is “review for shoe 1.” Similar searches can be generated for each other shoe. Once search results for all the search queries have been received, the information can be sent to a response generator (e.g., a response generation model) to prepare a query response for display to a user.

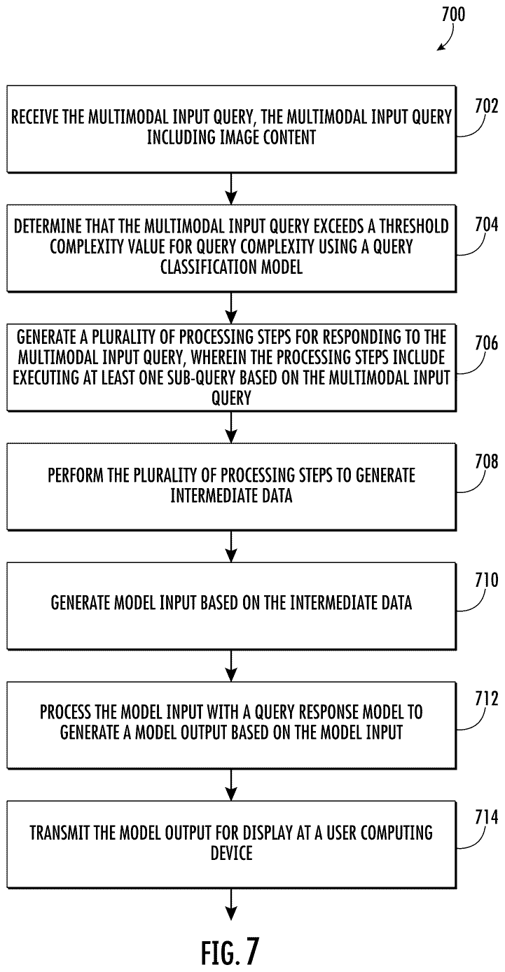

FIG. 7 is a flow diagram representing a process for generating responses for complex multimodal input queries in accordance with example embodiments of the present disclosure. The process can be performed by a computing system. The computing system can comprise one or more processors and one or more non-transitory computer-readable media that store instructions. In some examples, the computing system can include a query response system. The query response system can, at 702, receive the multimodal input query, the multimodal input query including image content. In some examples, the multimodal input query includes textual content or speech content.

The query response system can, at 704, determine that the multimodal input query exceeds a threshold complexity value for query complexity using a query classification model. In some examples, determining, by the computing system, that the multimodal input query exceeds a threshold complexity value for query complexity using a query classification model further comprises providing the multimodal input query as input to the query classification model. The query response system can receive a complexity score for the multimodal input query as output from the query classification model. The query classification model can be a machine-learned model that can take a multimodal modal as input and can output a complexity score.

The query response system can compare the complexity score for the multimodal input query to the threshold complexity value. In some examples, the query classification model is a large vision language model. In some examples, the complexity value can be a value between 0 and 1 and the threshold value can be based on a determination of the percentage of multimodal input queries that benefit from a multi-step reasoning approach.

In response to determining that the multimodal input query exceeds a threshold for complexity, the query response system can, at 706, generate a plurality of processing steps for responding to the multimodal input query, wherein the processing steps include executing at least one subquery based on the multimodal input query. In some examples, the plurality of processing steps are represented as a list of processing steps. In some examples, each processing step is represented as a computing instruction.

The query response system can, at 708, perform the plurality of processing steps to generate intermediate data. In some examples, the one or more processing steps comprise one or more of: object recognition, data retrieval, subquery execution, and data synthesization. For example, if a respective processing step includes object recognition, the orchestration system can provide the image content to an object recognition model, wherein the object recognition model is a visual machine-learned model trained to take an image as input. The orchestration system can receive a list of detected objects as output from the object recognition model.

In another example, the respective processing step includes subquery execution, and the orchestration system can generate at least one subquery based on the multimodal input query and at least one object in the list of detected objects. The orchestration system can provide the at least one subquery to a search system. The orchestration system can receive one or more search results in response to the at least one subquery from the search system.

In other examples, the respective processing step includes a synthesis step, and the orchestration system can aggregate the one or more search results to generate combined search data. The orchestration system can generate a respective subquery using data from the combined search result data.

The orchestration system can determine whether the intermediate data is sufficient to respond to the multimodal input query. Responsive to determining that the intermediate data is not sufficient to respond to the multimodal query, the orchestration system can generate additional processing steps for responding to the multimodal input query. The orchestration system can perform the additional processing steps to generate updated intermediate data. The orchestration system can continue to generate and perform additional processing steps until the updated intermediate data is determined to be sufficient to respond to the multimodal input query.

The query response system can, at 710, generate model input based on the intermediate data. In some examples, the model input includes citation data. The query response system can, at 712, process the model input with a query response model to generate a model output based on the model input. In some examples, the model output comprises a natural language response to the multimodal input query. The query response system can, at 714, transmit the model output for display at a user computing device. In some examples, the model output can comprise citation data for data generated by the response generation model. In some examples, the model output is displayed on a page of search results. In some examples, the search results are multimodal.

FIG. 8 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of a message generation model. Although various features, variations, and implementations described below are described with respect to machine-learned model(s) 1, it is to be understood that such features, variations, and implementations are to be understood as described with respect to the message generation model, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single, or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

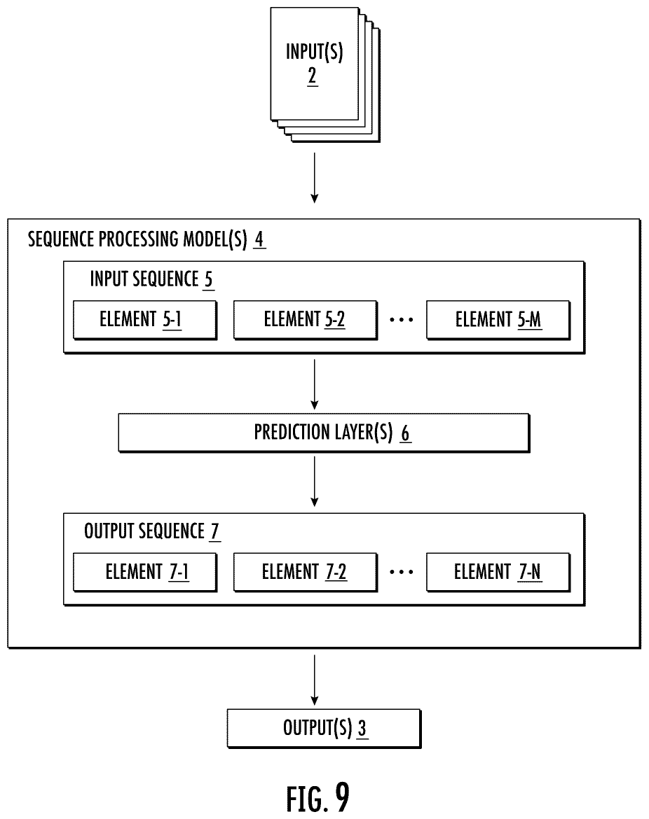

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 9 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

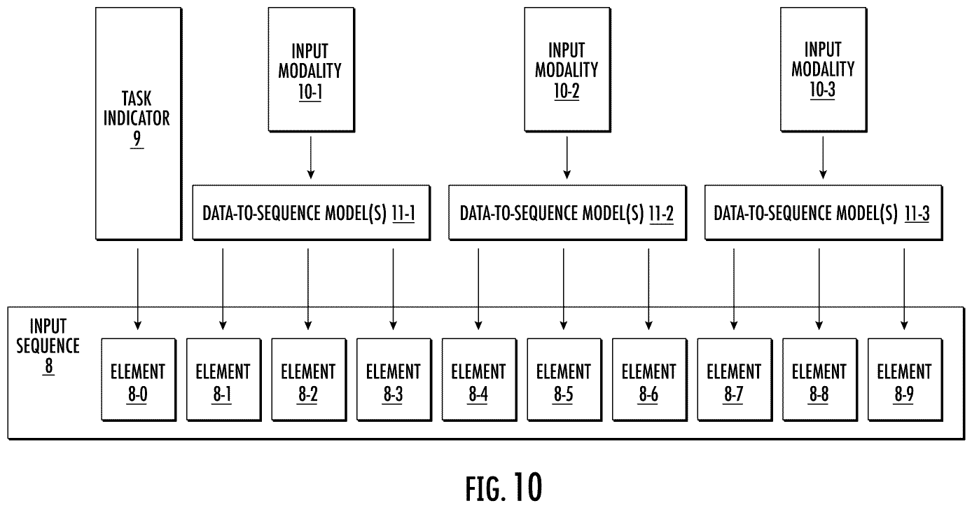

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

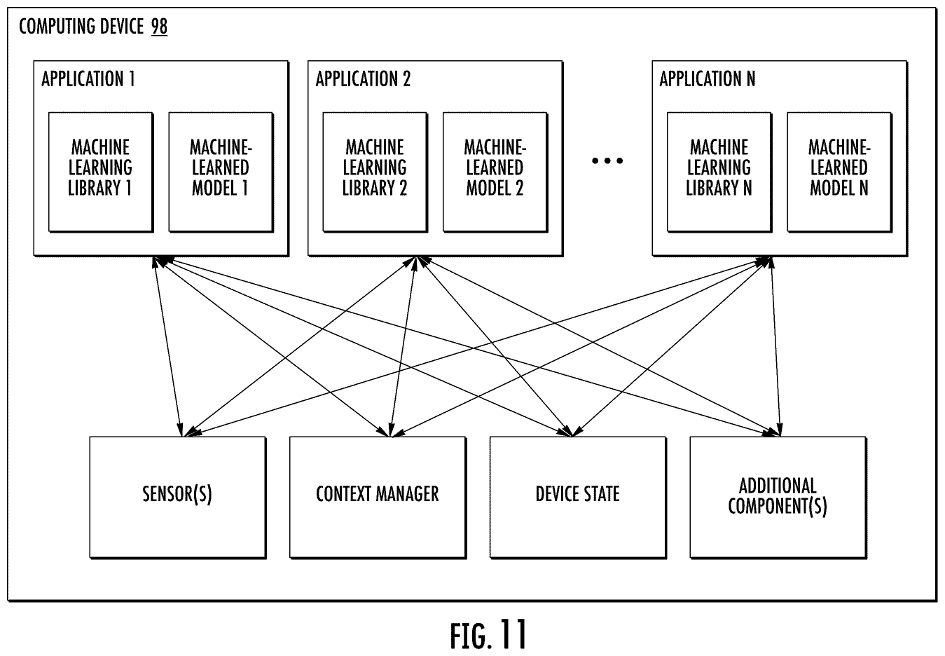

FIG. 11 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine-learned library and machine-learned model(s). For example, each application can include a machine-learned model. Example applications include a text messaging application, an email application, a dictation application, a virtual keyboard application, a browser application, etc. As illustrated in FIG. 11, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

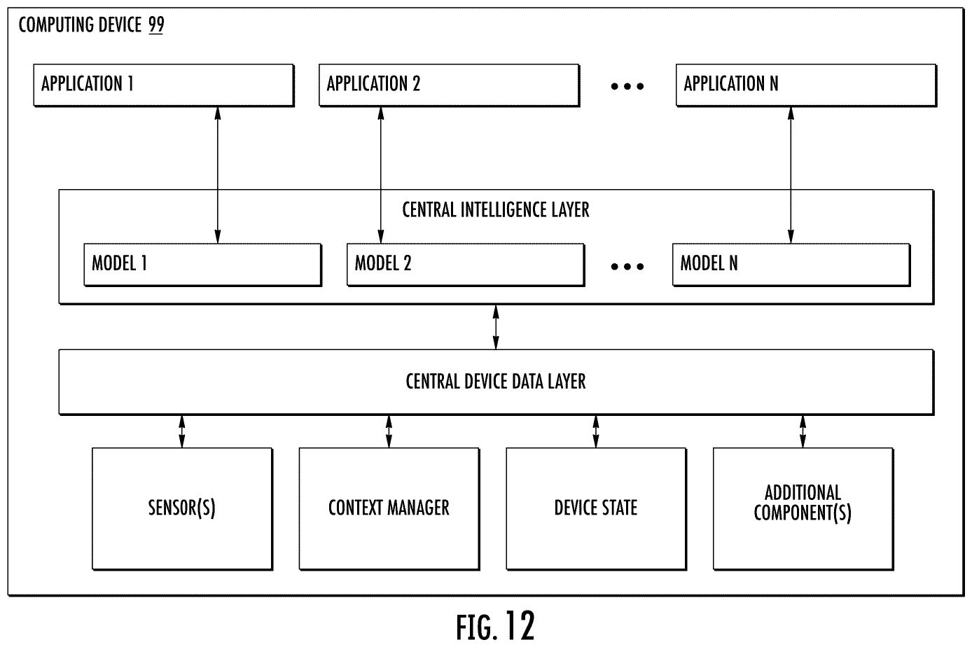

FIG. 12 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 12, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 12, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for responding to a multimodal input query with a large-language model using a multi-step reasoning process, the method comprising:
receiving, by a computing system with one or more processors, the multimodal input query, the multimodal input query including image content;
determining, by the computing system, that the multimodal input query exceeds a threshold complexity value for query complexity using a query classification model;
in response to determining that the multimodal input query exceeds a threshold complexity value:
generating, the computing system, a plurality of processing steps for responding to the multimodal input query, wherein the processing steps include executing at least one subquery based on the multimodal input query;
performing, by the computing system, the plurality of processing steps to generate intermediate data; and
generating, by the computing system, input based on the intermediate data;
processing, by the computing system, the model input with a query response model to generate a model output based on the model input; and
transmitting, by the computing system, the model output for display at a user computing device.

2. The computer-implemented method of claim 1, wherein the multimodal input query includes textual content or speech content.

3. The computer-implemented method of claim 1, wherein the plurality of processing steps are represented as a list of processing steps.

4. The computer-implemented method of claim 3, wherein each processing step is represented as a computing instruction.

5. The computer-implemented method of claim 4, the method further comprising, prior to summarizing, by the computing system, intermediate data into a model input:
determining, by the computing system, whether the intermediate data is sufficient to respond to the multimodal input query; and
responsive to determining that the intermediate data is not sufficient to respond to the multimodal query:
generating, by an orchestration model, additional processing steps for responding to the multimodal input query;
performing, by the computing system, the additional processing steps to generate updated intermediate data; and
continuing to generate and perform additional processing steps until the updated intermediate data is determined to be sufficient to respond to the multimodal input query.

6. The computer-implemented method of claim 5, wherein the one or more processing steps comprise one or more of: object recognition, data retrieval, subquery execution, and data synthesization.

7. The computer-implemented method of claim 6, wherein a respective processing step includes object recognition and the method further comprises:
providing, by the computing system, the image content to an object recognition model, wherein the object recognition model is a visual machine-learned model trained to take an image as input; and
receiving, by the computing system, a list of detected objects as output from the object recognition model.

8. The computer-implemented method of claim 7, wherein a respective processing step includes subquery execution, and the method further comprises:
generating, by the computing system, at least one subquery based on the multimodal input query and at least one object in the list of detected objects;
providing, by the computing system, the at least one subquery to a search system; and
receiving, by the computing system, one or more search results to the at least one subquery from the search system.

9. The computer-implemented method of claim 8, wherein a respective processing step includes a synthesization and the method further comprises:
aggregating, by the computing system, the one or more search results to generate combined search data; and
generating, by the computing system, a respective subquery using data from the combined search result data.

10. The computer-implemented method of claim 1, wherein determining, by the computing system, that the multimodal input query exceeds a threshold complexity value for query complexity using a query classification model further comprises:
providing, by the computing system, the multimodal input query as input to the query classification model;
receiving, by the computing system, a complexity score for the multimodal input query as output from the query classification model; and
comparing, by the computing system, the complexity score for the multimodal input query to the threshold complexity value.

11. The computer-implemented method of claim 10, wherein the query classification model is a machine-learned model trained to take a multimodal input query as input and output a complexity score.

12. The computer-implemented method of claim 1, wherein the query classification model is a large vision language model.

13. The computer-implemented method of claim 1, wherein the model output comprises a natural language response to the multimodal input query.

14. The computer-implemented method of claim 1, wherein the model input includes citation data.

15. The computer-implemented method of claim 1, wherein the model output comprises citation data for data generated by the response generation model.

16. The computer-implemented method of claim 1, wherein the model output is displayed on a page of search results.

17. The computer-implemented method of claim 16, wherein the search results are multimodal.

18. A computing system, comprising:
one or more processors; and
one or more non-transitory computer-readable media that store instructions wherein, when executed by the one or more processors, the instructions cause the one or more processors to perform operations, the operations comprising:
receiving the multimodal input query, the multimodal input query including image content;
determining that the multimodal input query exceeds a threshold complexity value for query complexity using a query classification model;
in response to determining that the multimodal input query exceeds a threshold complexity value:
generating a plurality of processing steps for responding to the multimodal input query, wherein the processing steps include executing at least one subquery based on the multimodal input query;
performing the plurality of processing steps to generate intermediate data;
generating model input based on the intermediate data;
processing the model input with a query response model to generate a model output based on the model input; and
transmitting the model output for display at a user computing device.

19. The computing system of claim 18, wherein the multimodal input query includes textual content or speech content.

20. One or more non-transitory computer-readable media that collectively store instructions that, when executed by one or more computing devices, cause the one or more computing devices to perform operations, the operations comprising:
receiving the multimodal input query, the multimodal input query including image content;
determining that the multimodal input query exceeds a threshold complexity value for query complexity using a query classification model;
in response to determining that the multimodal input query exceeds a threshold complexity value:
generating a plurality of processing steps for responding to the multimodal input query, wherein the processing steps include executing at least one subquery based on the multimodal input query;
performing the plurality of processing steps to generate intermediate data;
generating model input based on the intermediate data;
processing the model input with a query response model to generate a model output based on the model input; and
transmitting the model output for display at a user computing device.
